(19) United States
(12) Patent Application Publication
(10) Pub. No.: US 2017/0155744 A1
(43) Pub. Date: Jun. 1, 2017

(54) NETWORK PACKET MANAGEMENT SERVER, NETWORK PACKET MANAGEMENT METHOD AND COMPUTER READABLE MEDIUM THEREOF

(71) Applicant: Institute For Information Industry, Taipei (TW)

(72) Inventors: Chao-Hsien LEE, Taipei City (TW); Ying-Hsun LAI, Kaohsiung City (TW); Yu-Hsiu LIN, New Taipei City (TW); Chi-Cheng CHUANG, Kaohsiung City (TW)

(21) Appl. No.: 14/963,218

(22) Filed: Dec. 8, 2015

(30) Foreign Application Priority Data
Nov. 26, 2015 (TW) 104139393

(51) Int. Cl. H04L 29/06; H04L 5/00; H04L 12/66; H04L 12/24

(52) U.S. Cl. CPC H04L 69/22; H04L 41/22; H04L 5/0055; H04L 12/66

(57) ABSTRACT

A network packet management server, a network packet management method and a computer readable medium thereof are provided. The network packet management server runs a packet management program which includes a graphical user interface (GUI) to execute the packet management method. The network packet management server receives internet of things (IoT) device information through a network, generates header field analysis information in response to an operation on the GUI, and generates a packet processing prediction message according to the header field analysis information and the IoT device information. Accordingly, the network packet management server is able to generate at least one control message based on the packet processing prediction message so as to send the at least one control message to at least one of a network control device and a gateway via the network.

### PRIORITY

This application claims the benefit of priority based on Taiwan Patent Application No. 104139393 filed on Nov. 26, 2015, which is hereby incorporated by reference in its entirety.

### FIELD

The present invention relates to a network packet management server, a network packet management method and a non-transitory tangible computer readable medium thereof. More particularly, the network packet management server of the present invention can generate a packet processing prediction message according to packet edition information and internet of things (IoT) device information, and further generate at least one control message according to the packet processing prediction message, thereby editing and managing the packet.

### BACKGROUND

With the development of the network communication technology in recent years, more and more devices with the network communication function have been widely used in people's daily life. For example, nowadays, various hand-held devices can access data stored in cloud servers via networks, and many kinds of sensing devices (e.g., sensing devices for temperature monitoring) can continuously upload sensing data to the cloud servers via the networks. An internet of things (IoT) can be formed by networking various devices to make the devices capable of data transmission.

Currently, application of the IoT can help network administrators to monitor and manage a device more conveniently. However, the transmission environment of the IoT is highly heterogeneous because there are numerous IoT transmission standards and the transmission protocols defined or used by the IoT transmission standards are also different from each other. Moreover, hardware specifications of the IoT devices are also different from each other, so the IoT protocol and the transmission performance thereof supported by one IoT device are also different from those supported by another IoT device. Thus, as compared to general network environments, network protocols corresponding to different demands and qualities need to be made for various scenarios in the IoT environment, and change and expansion of application layer network protocols need to be supported flexibly to a greater extent. In this case, if the network administrators want to change and expand the protocols in the IoT environment, then they shall evaluate whether the changed and expanded protocols are suitable for the current IoT environment by performing complicated setting and testing operations, and the evaluation result usually can only be decided based on the experience of the network administrators. In other words, currently there lacks a convenient mechanism that assists the network administrators in changing and expanding the protocols of the IoT environment and performing evaluation in advance.

Accordingly, an urgent need exists in the art to provide a packet management mechanism that assists the network administrators in changing and expanding the protocols of the IoT environment and performing evaluation in advance so as to meet the service quality requirements of the IoT network.

### SUMMARY

The disclosure includes a packet management mechanism, which can assist the network administrator in evaluating in advance whether a packet management demand thereof is suitable for the current IoT environment according to the packet management demand of the network administrator and further based on the capacity of an IoT device, and automatically generate a control message in response to the acknowledgement of the network administrator so as to control a gateway or other network controlling devices connected to the IoT device.

The disclosure includes a network packet management server. The network packet management server comprises a network interface, a storage medium and a processor. The network interface is connected to a network and configured to receive internet of things (IoT) device information via the network and is connected to a network control device and a gateway via the network. The storage medium is configured to store the IoT device information and a packet management program. The packet management program includes a graphics user interface (GUI). The processor is electrically connected to the network interface and the storage medium and is configured to run the packet management program so as to generate header field analysis information in response to an operation on the GUI, generate a packet processing prediction message according to the header field analysis information and the IoT device information, generate at least one control message according to the packet processing prediction message, and transmit the at least one control message to at least one of the network control device and the gateway via the network interface.

The Disclosure also includes a network packet management method for use in a network packet management server. The network packet management server comprises a network interface, a storage medium and a processor. The network interface connects to a network and connects to a network control device and a gateway via the network. The storage medium stores a packet management program. The packet management program includes a GUI. The processor is electrically connected to the network interface and the storage medium. The network packet management method is executed by the processor through running the packet management program and comprises the following steps of: receiving IoT device information through the network interface and via the network, and storing the IoT device information into the storage medium; generating header field analysis information in response to an operation on the GUI; generating a packet processing prediction message according to the header field analysis information and the IoT device information; generating at least one control message according to the packet processing prediction message; and transmitting the at least one control message to at least one of the network control device and the gateway via the network interface.

The disclosure further includes a non-transitory tangible computer readable medium with a packet management program stored therein, and the packet management program includes a GUI and a plurality of codes. When the packet management program is loaded and installed into a network packet management server, the codes are executed by the network packet management server to execute a network packet management method. The network packet management server connects to a network. The network packet management method comprises the following steps of: receiving IoT device information via the network, and storing the IoT device information; generating header field analysis information in response to an operation on the GUI; generating a packet processing prediction message according to the header field analysis information and the IoT device information; generating at least one control message according to the packet processing prediction message; and transmitting the at least one control message to at least one of the network control device and the gateway.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a network packet management server 1 according to the first embodiment of the present invention;

FIG. 2A to FIG. 2D depict different network architectures 2_1, 2_2, 2_3 and 2_4 of the present invention;

FIG. 3A illustrates using a personal computer PC31 to access the network packet management server 1 of the present invention;

FIG. 3B to FIG. 3E are schematic views illustrating graphic user interfaces (GUIs) according to the second embodiment of the present invention;

FIG. 4 is a schematic view depicting that a field rule algorithm is used to calculate a calculation complexity 41 and a calculation storage amount 43 based on header field analysis information according to the third embodiment of the present invention;

FIG. 5 is a schematic view depicting that a control message is generated based on the calculation complexity 41 and the calculation storage amount 43 and IoT device information 102 according to the third embodiment of the present invention;

FIG. 6 is a flowchart diagram of a network packet management method according to the fourth embodiment of the present invention;

FIG. 7 is a flowchart diagram depicting additional steps in a network packet management method according to another embodiment of the present invention; and

FIG. 8 is a flowchart diagram depicting additional steps in a network packet management method according to another embodiment of the present invention.

### DETAILED DESCRIPTION

In the following description, the present invention will be explained with reference to certain example embodiments thereof. The examples include a network packet management server, a network packet management method and a non-transitory tangible computer readable medium thereof. It shall be appreciated that, these example embodiments are not intended to limit the present invention to any particular example, embodiment, environment, applications or implementations described in these example embodiments. Therefore, description of these example embodiments is only for purpose of illustration rather than to limit the present invention, and the scope claimed in this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

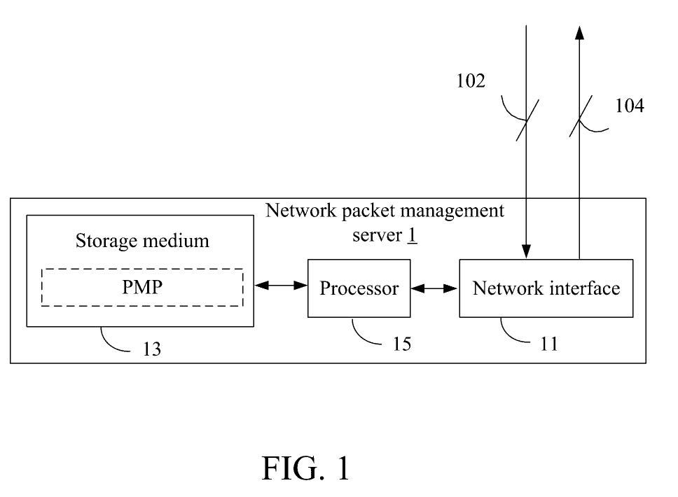

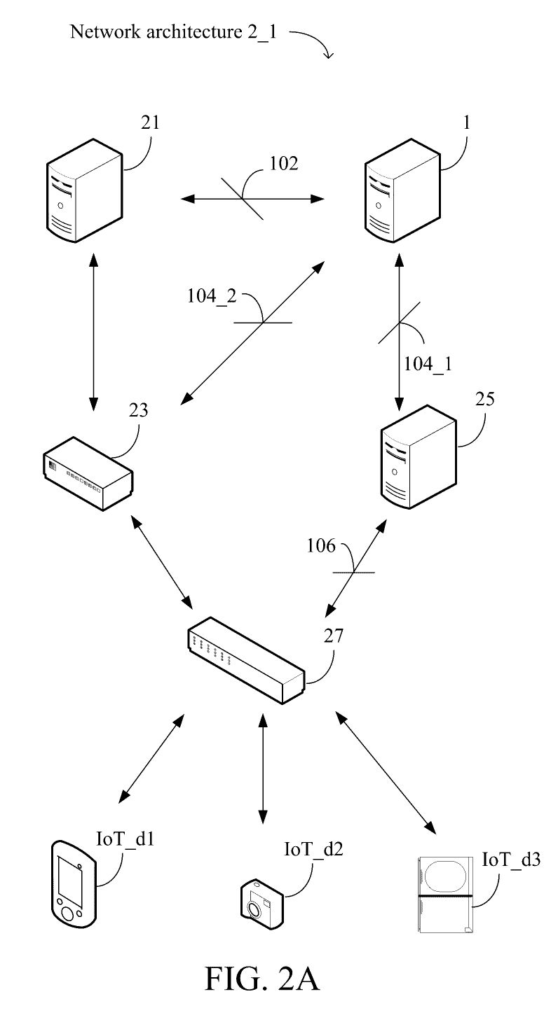

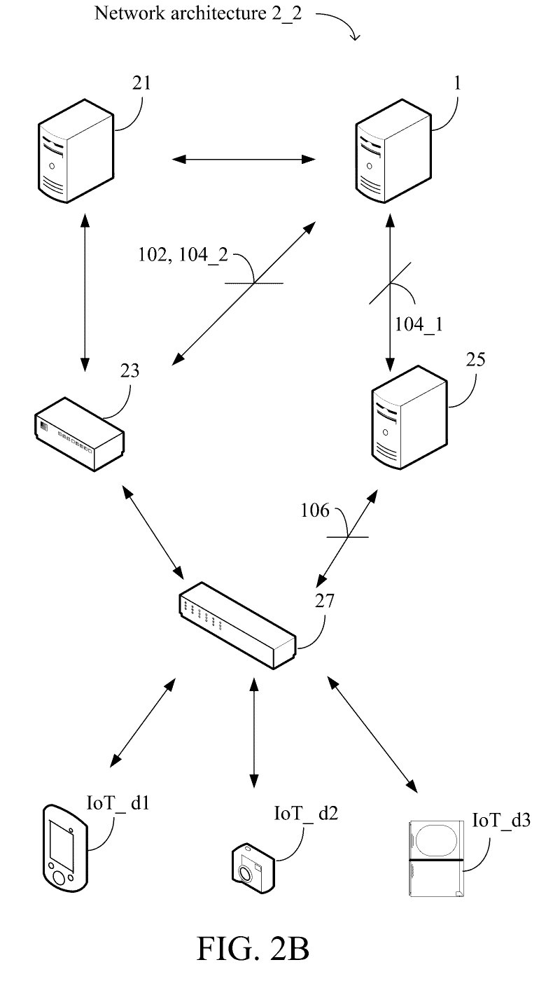

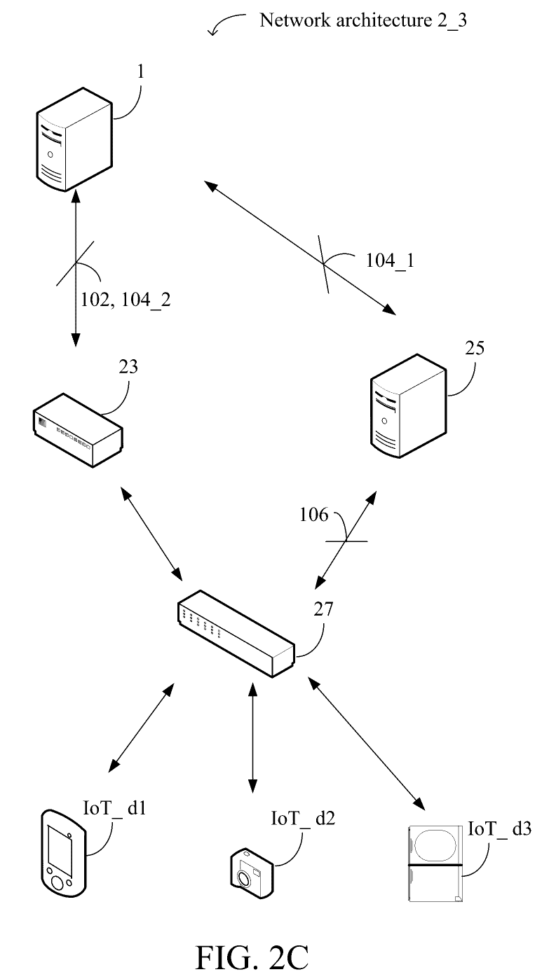

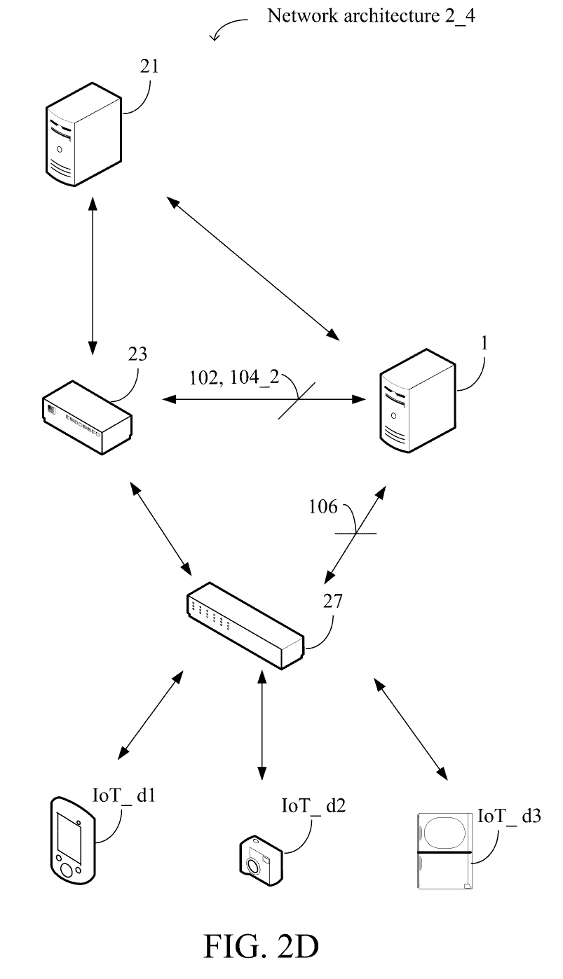

Please refer to FIG. 1 and FIG. 2A to FIG. 2D for the first embodiment of the present invention. FIG. 1 is a schematic view of a network packet management server 1 of the present invention. FIG. 2A to FIG. 2D are schematic views depicting the network packet management server 1 under different network architectures 2_1, 2_2, 2_3 and 2_4 respectively. The network packet management server 1 of the present invention can be used by a network administrator to manage, edit, monitor, and maintain the packet transmission under the internet of thing (IoT) and thereby perform network monitoring and performance analysis or the like under the IoT. As shown in FIG. 1, the network packet management server 1 of the present invention comprises a network interface 11, a storage medium 13 and a processor 15. The storage medium 13 may be a flash memory, a hard disc or any storage medium having the same function.

The network interface 11 of the network packet management server 1 connects to a network (not shown), and can receive internet of things (IoT) device information 102 via the network and it also connects to a network control device and a gateway via the network. In the present invention, the network control device may be a software defined network (SDN) controller or a switch. It shall be noted that, the aforesaid network may be a local area network, the Internet, a telecommunication network or any combination thereof, but it is not limited thereto.

The IoT device may be a device capable of network connected (wireless/wired) transmission. For example, the IoT device may be an intelligent home appliance, an environment sensing device (a temperature/humidity sensor, an optical sensor and a CO or CO₂ sensor) or a power sensing device (an intelligent socket, a power meter) or the like, but it is not limited thereto.

For example, under the network architectures 2_1 and 2_2 of FIG. 2A and FIG. 2B, the network packet management server 1 of the present invention is an independent network server, and the network interface 11 thereof can connect to a cloud server 21, a gateway 23 and an SDN controller 25 via the network. Moreover, the cloud server 21 connects to the gateway 23 via the network, and the gateway 23 and the SDN controller 25 are respectively connected to the switch 27 via the network. Various IoT devices (e.g., a hand-held device IoT_d1, a camera IoT_d2 and a refrigerator IoT_d3, but not limited thereto) may also be connected to the switch 27 via the network.

The network interface 11 receives the IoT device information 102 from the cloud server 21, or receives the IoT device information 102 from the gateway 23. The IoT device information 102 may comprise capacity information of various devices (e.g., specification information of the device, which includes the clock pulse of a processor, the capacity of a memory, the available electricity quantity, and the load capacity of the network, but is not limited thereto). The storage medium 13 is configured to store the IoT device information 102 and a packet management program (PMP).

In detail, the packet management program PMP is loaded and installed into the network packet management server 1 so that the network packet management server 1 executes the packet management mechanism of the present invention. The packet management program PMP has a graphical user interface (GUI), via which a user (e.g., the network administrator) can input packet edition information. Schematic description of the GUI will be detailed later.

It shall be appreciated that, once any of the IoT devices under the network architecture has been changed, the network packet management server 1 receives the IoT device information 102 via the network, so the network packet management server 1 will continuously receive the IoT device information 102, and the packet management program PMP may record the IoT device information 102 in the form of a device evaluation database so that the IoT device information 102 is stored into the storage medium 13. In other words, in addition to at least the IoT device information of the currently connected IoT devices (e.g., the hand-held device IoT_d1, the camera IoT_d2 and the refrigerator IoT_d3), the device evaluation database (i.e., the IoT device information 102 stored in the storage medium 13) may further include the IoT device information of the once connected IoT devices.

The processor 15 is electrically connected to the network interface 11 and the storage medium 13 and is configured to run the packet management program PMP. When the user inputs the packet edition information via the GUI, the processor 15 generates header field analysis information in response to the operation of the user on the GUI (i.e., in response to the input of the packet edition information). Specifically, the packet edition information may be packet format information, comparison condition information and translation condition information or the like, but it is not limited thereto. The header field analysis information is generated by the packet management program PMP through further analyzing the packet edition information, and it may include but is not limited to: protocol layering information, protocol number information, header length information, field type information, field number information, and nested depth information or the like. On the other hand, the packet management program PMP may also record the header field analysis information in the form of a packet format database so that the header field analysis information is stored into the storage medium 13.

Next, the packet management program PMP may read the IoT device information 102 from the device evaluation database stored in the storage medium 13, and read the header field analysis information from the packet format database stored in the storage medium 13. Then, the packet management program PMP generates a packet processing prediction message according to the header field analysis information and the IoT device information 102. Specifically, the packet processing prediction message is generated by the network packet management server 1 according to the packet edition information inputted by the user and further based on the capacity of the IoT devices (e.g., the clock pulse of the processor, the capacity of the memory or the like as described above). Finally, the packet management program PMP may further generate at least one control message 104 (e.g., a control message 104_1 and a control message 104_2) according to the packet processing prediction message so as to transmit the at least one control message 104 to at least one of the network control device and the gateway 23 via the network interface 11.

As shown in FIG. 2A to FIG. 2B, the network packet management server 1 can transmit the control message 104_2 to the gateway 23, and/or transmit the control message 104_1 to the SDN controller 25, and thereby the gateway 23 and/or the SDN controller 25 may perform corresponding operations respectively according to the received control message 104_1 and the control message 104_2. For example, the gateway 23 may perform protocol translation on the packet in response to the control message 104_2, and the SDN controller 25 may set the switch 27 to control the transmission path of the packet in response to the control message 104_1.

Further speaking, in the present invention, the control message 104_2 is generated based on the control protocol provided by the gateway 23, e.g., the HyperText Transfer Protocol (HTTP); the control message 104_1 is generated based on the software-defined network (SDN) technology used by the SDN controller 25, e.g., the protocol oblivious forwarding (POF) or the Programming Protocol-Independent Packet Processors (called P4 for short) in the new generation of OpenFlow 2.0. How the control messages 104_1 and 104_2 are generated shall be readily appreciated by those of ordinary skill in the art based on the aforesaid description, and thus will not be further described herein. Additionally, after receiving the control message 104_1 based on the OpenFlow 2.0, the SDN controller 25 also generates another control message 106 to the switch 27 based on the OpenFlow 2.0.

In the network architecture 2_3 of another implementation, as shown in FIG. 2C, the network packet management server 1 may also serve as a cloud server at the same time and is not another independent network server. In other words, as compared to the network architectures 2_1 and 2_2 of FIG. 2A to FIG. 2B, the packet management program PMP in this implementation is loaded and installed into the cloud server 21 as shown in FIG. 2A to FIG. 2B to achieve the aforesaid packet edition and management. In detail, in the network architecture 2_3, the network packet management server 1 receives the IoT device information 102 directly from the gateway 23. Similarly, the network packet management server 1 may respectively transmit the control message 104_1 to an SDN controller 25 and/or transmit the control message 104_2 to the gateway 23, and the SDN controller 25 may further transmit a control message 26 to the switch 27.

Moreover, in the network architecture 2_4 as shown in FIG. 2D, the network packet management server 1 may also serve as an SDN controller at the same time and is not another independent network server. In other words, as compared to the aforesaid network architectures 2_1 and 2_2, the packet management program PMP in this implementation is loaded and installed into the SDN controller 25 as shown in FIG. 2A to FIG. 2B to achieve the aforesaid packet edition and management. In this case, the network packet management server 1 can directly connect to the switch 27 via the network and transmit the control message 104_2 generated by the network packet management server 1 to the gateway 23, and/or generate the control message 106 directly based on the generated packet processing prediction message, and transmit the control message 106 to the switch 27.

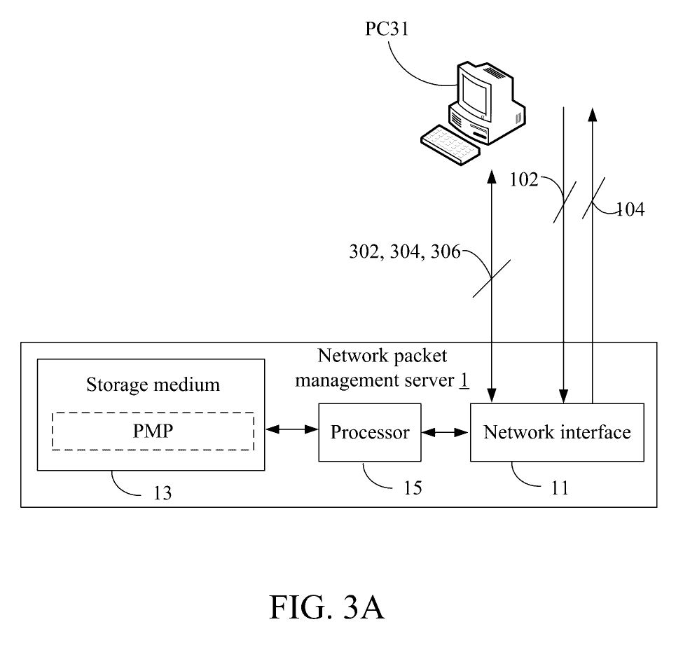

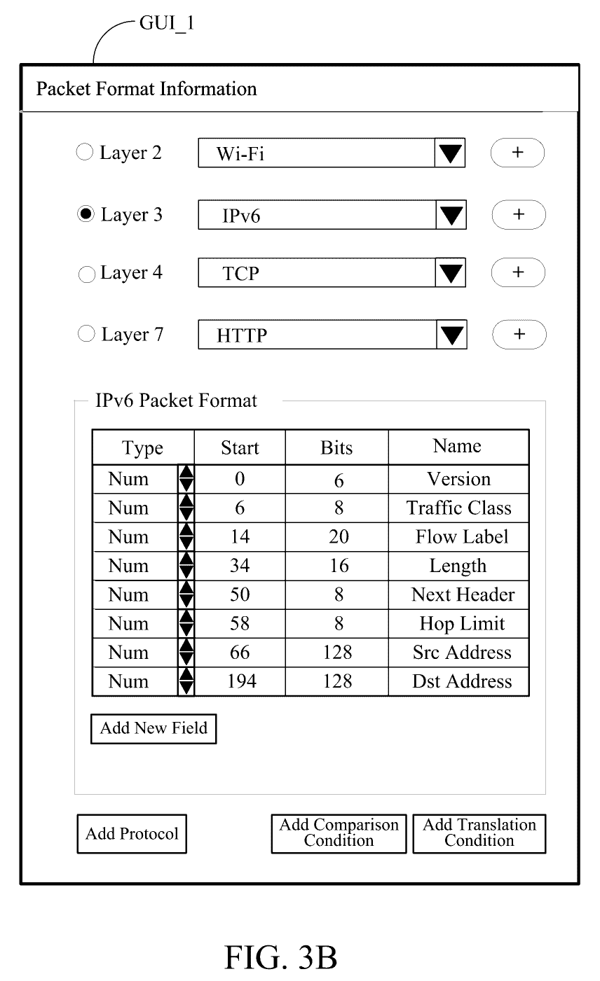

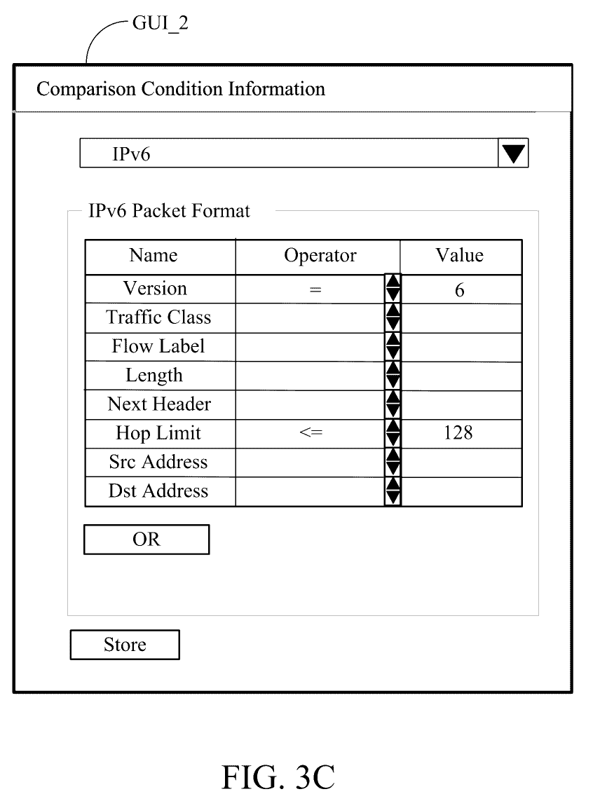

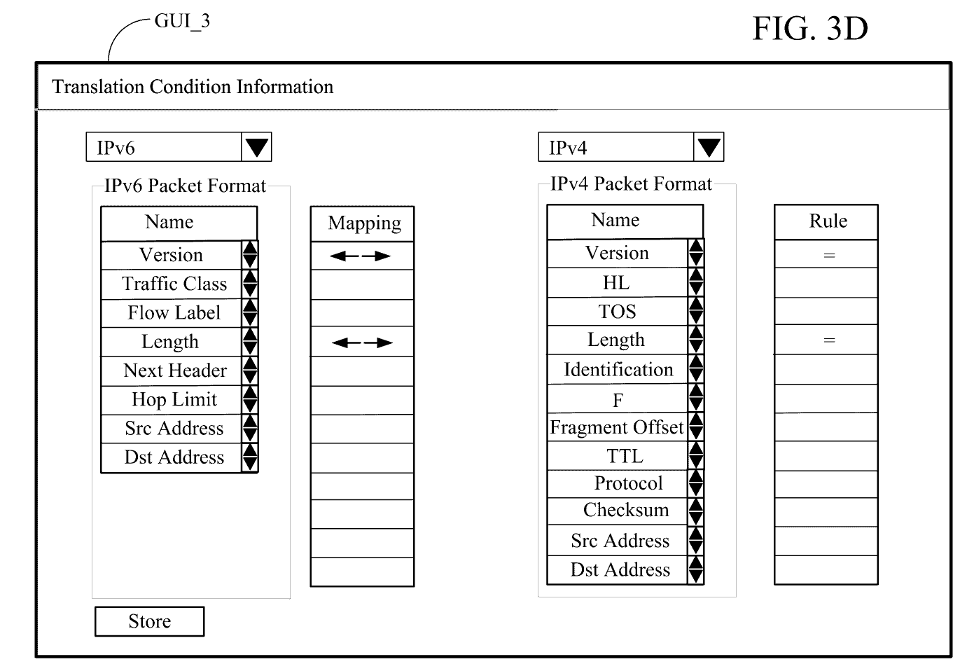

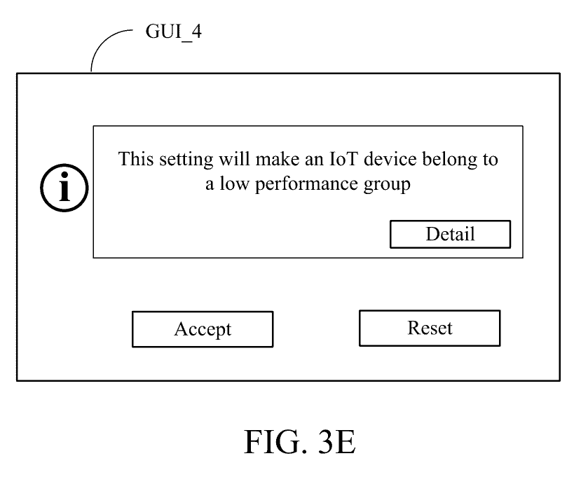

The second embodiment of the present invention is as shown in FIG. 3A to FIG. 3E, which depict an implementation of graphic user interfaces (GUIs) of the present invention. It shall be appreciated that, the GUIs depicted in this embodiment are only used to make it convenient to describe how the user (i.e., the network administrator) inputs packet edition information via the GUIs and generates the control message to manage the packet transmission, and are not intended to limit the design of the GUI of the present invention. Moreover, the network administrator may operate the GUI directly on the network packet management server 1, or the network administrator may access the network packet management server 1 via other UEs (e.g., via a personal computer PC31, as shown in FIG. 3A) to access the GUI and perform a series of operations as described hereinbelow.

As described above, the network administrator may access the GUI directly on the network packet management server 1. In this scenario, the network packet management server 1 further comprises an input interface (not shown) and a display module (not shown). The input interface and the display module are electrically connected to the processor 15. The display module may be configured to display the GUI. When the network administrator inputs the packet edition information on the GUI using an input interface (e.g., a physical mouse, a physical keyboard, a touch virtual keyboard or the like), the input interface can generate an input signal in response to the operation of the network administrator on the GUI, and the packet management program PMP further enables the GUI to present packet edition information according to the input signal. Accordingly, the packet management program PMP further generates the header field analysis information according to the packet edition information.

As described above, the packet edition information presented by the GUI may comprise packet format information, comparison condition information and translation condition information or the like, which may be as shown in FIG. 3B, FIG. 3C and FIG. 3D respectively. First, as shown in FIG. 3B, the network administrator may input the “Packet Format Information” on the graphical user interface GUI_1. In detail, the network administrator may select a layer on which the packet edition or management is to be performed, e.g., the layer 2, the layer 3, the layer 4, or the layer 7. In this embodiment, the layer 1 to the layer 7 are respectively a physical layer, a data link layer, a network layer, a transport layer, a session layer, a presentation layer and an application layer.

After selecting the layer, the network administrator may further select a known protocol through a pull-down menu. For example, if the network administrator wants to edit or manage the packet of the layer 3 and wants to select a known protocol IPv6, then he/she may first click on and select the “Layer 3” on the graphical user interface GUI_1 and then select the “IPv6” through the pull-down menu corresponding to the “Layer 3”. Furthermore, if the network administrator wants to add an additional protocol on his/her own, then he/she may further click on and select the “+” button next to the pull-down menu to add an additional protocol.

After the network administrator has selected the packet of the layer 3 and the corresponding IPv6 protocol thereof, a “Packet Format” belonging to the “IPv6 Protocol” may be presented on the graphical user interface GUI_1 (i.e., information of the “IPv6 Packet Format” is presented on the graphical user interface GUI_1). The “Packet Format” may include many fields, e.g., fields (columns) such as “Type”, “Start”, “Bits”, “Name” or the like. The column “Type” indicates whether the packet field is of a digital format or a text format, the column “Start” indicates the start bit of the field, the column “Bits” indicates the length of the field, and the column “Name” indicates the name of the field.

It shall be appreciated that, if the existing fields presented in the “Packet Format” are insufficient, then the network administrator may click on the key “Add New Field” and thereby add new fields into the selected protocol. On the other hand, a network administrator who wants to edit the packets of several protocols at the same time may click on the key “Add Protocol” to enable the GUI to present another picture “Packet Edition Information” so that the network administrator can edit other relevant protocols. It shall be appreciated that, as mentioned above, the GUI presented in this embodiment is only used to make it convenient to describe how the network administrator performs the operation on the GUI of the present invention, and is not intended to limit the present invention.

Once the network administrator has selected a certain protocol (e.g., the protocol IPv6), the network administrator may click on the key “Add Comparison Condition”, and then a picture presenting a graphical user interface GUI_2 shown in FIG. 3C will be displayed. The graphical user interface GUI_2 displays the “Comparison Condition Information”, and the network administrator may select specific fields (e.g., the field “Version” and the field “Hop Limit”) of the protocol IPv6 on the graphical user interface GUI_2 so as to add the comparison condition. Further speaking, the network administrator may input operators including “=” (Equal), “!=” (Unequal), “>” (Greater than), “<” (Less than) or the like into a field “Operator”, and input specified value contents into the field “Value”. For example, as shown in FIG. 3C, the network administrator selects the field “Version” of the protocol IPv6 to compare packets of which the conditions are equal to 6, and further selects the field “Hop Limit” of the protocol IPv6 to compare packets of which the conditions are less than or equal to (<=) 128. After the network administrator has finished inputting the comparison condition, he/she may click on the key “Store” so that the comparison condition information is further stored.

On the other hand, as shown in FIG. 3B, after the network administrator has selected a particular protocol, the network administrator may further click on the key “Add Translation Condition”, and then a picture presenting a graphical user interface GUI_3 of FIG. 3D will be displayed. The graphical user interface GUI_3 displays the “Translation Condition Information”. The graphical user interface GUI_3 allows the network administrator to select two protocols and set the translation between the fields of these two protocols. In detail, the order of the fields presented in the graphical user interface GUI_3 is preset, and it may be preset that the fields are sorted in ascending order of the start bits. Each field in each of the protocols has a pull-down menu so that the order in which different fields are sorted can be changed. When the network administrator wants to perform translation on particular fields, then the to-be-translated fields corresponding to different protocols need to be aligned (i.e., it is necessary to ensure that the corresponding fields are sorted in the same order between these two protocols).

For example, if the network administrator wants to perform translation between the field “Version” of the protocol IPv6 and the field “Version” of the protocol IPv4, and perform translation between the field “Length” of the protocol IPv6 and the field “Length” of the protocol IPv4, then it is necessary to determine whether the fields “Version” of the two protocols are aligned and whether the fields “Length” of the two protocols are aligned. If the aforesaid fields have not yet been aligned, then the order of the fields may be changed through the pull-down menu. Next, a rule for the translation is set. For example, when the values of the fields of the two protocols can be directly copied from each other, then the operator “=” may be selected in a field “Rule”. If the fields require string processing, then the regular expression (not shown) may be selected for the string processing.

After the network administrator has inputted the “Packet Edition Information” as described above, the packet management program PMP can be executed to generate the header field analysis information as described in the first embodiment, and further generate the packet processing prediction message according to the header field analysis information and the IoT device information 102. Next, the packet management program PMP may further present a packet processing acknowledgement (ACK) information on the GUI according to the packet processing prediction message. For example, as shown in FIG. 3E, the packet processing ACK information may be presented on the graphical user interface GUI_4 after analysis and calculation so as to inform the network administrator of the packet processing prediction performance generated based on the packet edition set by the network administrator. If the network administrator is satisfied with the packet processing prediction performance, then he/she may further click on the key “Accept” so that the input interface further generates a packet processing ACK message in response to another operation of the network administrator on the graphical user interface GUI_4 (i.e., the operation of clicking on the key “Accept”). Accordingly, the packet management program PMP further generates at least one control message 104 according to the packet processing ACK message.

On the other hand, if the network administrator is not satisfied with the packet processing prediction performance, then he/she may further click on the key “Reset”, and thus the packet management program PMP will not generate the at least one control message 104 but return to the graphical user interface GUI_1 for resetting by the network administrator. In other words, the network packet management server 1 of the present invention can predict the packet processing performance for the network administrator in advance, and when the predicted packet processing performance meets the expectation, subsequent packet transmission and management can be performed according to the packet edition information inputted by the network administrator at that time. Otherwise, the network administrator may re-adjust the packet edition information until the analyzed packet processing prediction performance is relatively good, and then the control message 104 is generated accordingly to control at least one of a network control device (e.g., the SDN controller 25 or the switch 27) and the gateway 23.

Furthermore, there may also be a key “Detail” on the graphical user interface GUI_4 so that the network administrator can know the detailed packet processing prediction result. However, as described earlier, the graphical user interfaces GUI_1 to GUI_4 depicted in FIG. 3B to FIG. 3E are only illustrated for ease of description and are not intended to limit the design of the GUIs of the present invention. Accordingly, any design of the GUIs that can achieve the aforesaid functions of the present invention shall fall within the claimed scope of the present invention.

It shall be appreciated that, as described above, the network administrator may also access the network packet management server 1 via other UEs (e.g., via a personal computer PC31, as shown in FIG. 3A) to access the GUI, and thereby input the “Packet Edition Information” on the GUI. In this case, the network interface 11 of the network packet management server 1 may further receive packet edition information 302 from the network in response to an operation of a user on the GUI so that the packet management program PMP further generates the header field analysis information according to the packet edition information 302.

Similarly, after the network packet management server 1 has obtained the packet processing prediction message by analyzing relevant data, the packet management program PMP may further generate packet processing ACK information 304 according to the packet processing prediction message and transmit the packet processing ACK information 304 to the personal computer PC31 through the network interface 11. In this way, the packet processing ACK information 304 may be displayed on the GUI of the personal computer PC31 operated by the network administrator. If the network administrator is satisfied with the packet processing prediction result, then a packet processing ACK message 306 may be transmitted through the personal computer PC31. Thus, the network interface 11 further receives the packet processing ACK message 306 from the personal computer PC31 via the network so that the packet management program PMP generates at least one control message 104 according to the packet processing ACK message 306.

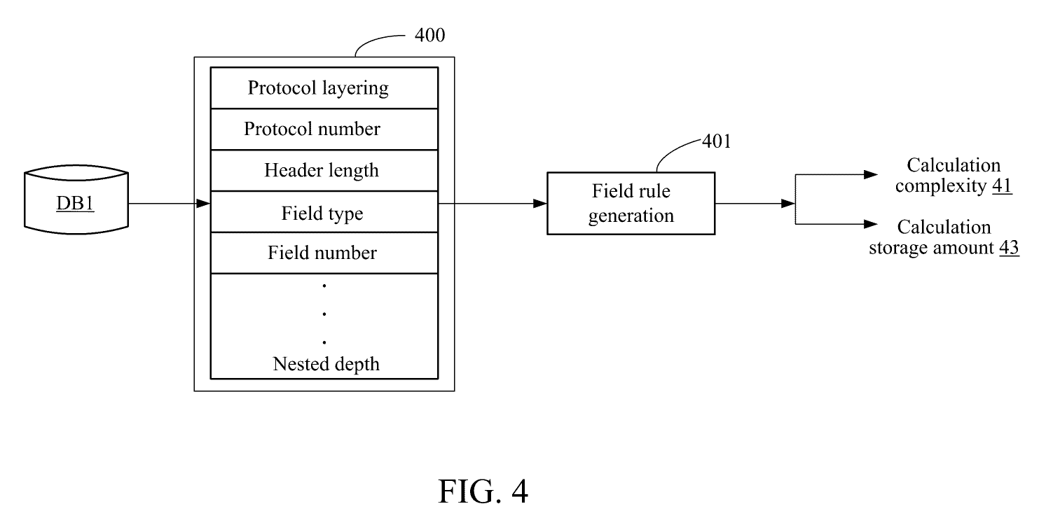

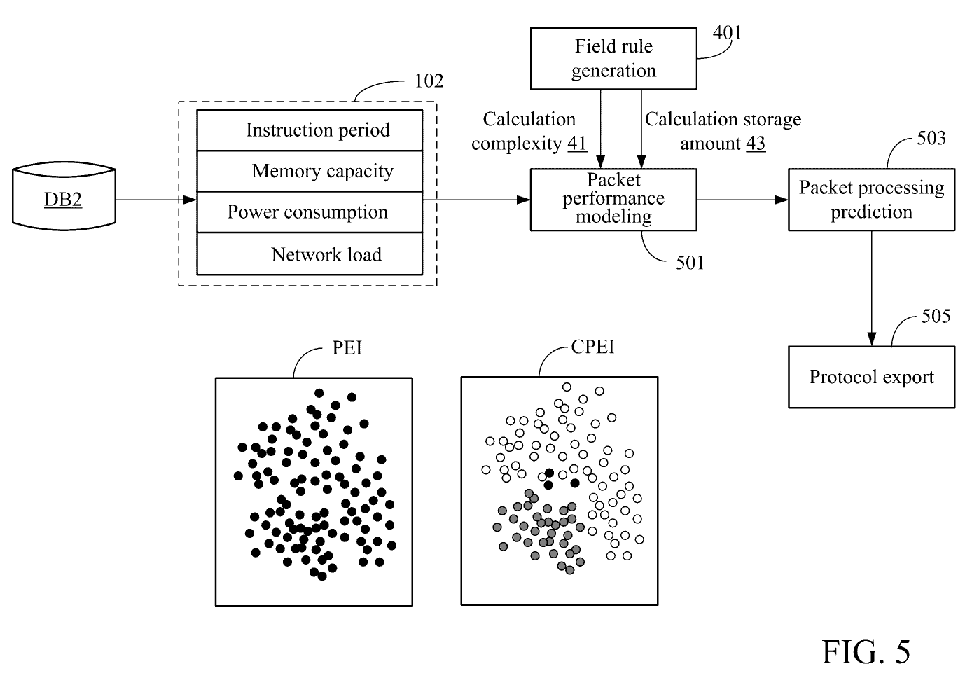

The third embodiment of the present invention is an extension of the first embodiment, and please further refer to FIG. 4 and FIG. 5 for the third embodiment. This embodiment further illustrates how the packet management program PMP generates the packet processing prediction message according to the header field analysis information and the IoT device information 102. Specifically, the packet management program PMP further uses a clustering algorithm to generate packet efficiency information PEI based on the header field analysis information and the IoT device information 102. For example, the packet management program PMP may utilize the clustering algorithm of the machine learning to decide the packet efficiency information PEI. The clustering algorithm may include the K-means, the K-medians, the Fuzzy C-means or the like, but it is not limited thereto.

Additionally, in this embodiment, in addition to the IoT device information 102 received from the cloud server 21 or from the gateway 23 as described above, the IoT device information 102 stored in the storage medium 13 may further include the specification information of IoT devices currently available on the market. By obtaining the IoT device information 102, the network packet management server 1 may first decide the packet efficiency information PEI. In other words, the packet efficiency information PEI indicates the result of considering the capacity of various kinds of IoT devices.

Next, the packet management program PMP further retrieves connected IoT device information from the IoT device information 102. Specifically, the network packet management server 1 may update IoT devices that are to perform data transmission at the present time or the connected IoT devices in real time. Accordingly, based on the connected IoT device information and the packet efficiency information PEI that is estimated earlier, the network packet management server 1 uses a classification algorithm to classify the packet efficiency information PEI and generate classified packet efficiency information CPEI, and generates the packet processing prediction message based on the distribution of the connected IoT device in the classified packet efficiency information CPEI. For example, the packet management program PMP may use the classification algorithm in the data mining, e.g., the K Nearest Neighbors (KNN) algorithm, the support vector machine (SVM) algorithm or the like (but not limited thereto).

Moreover, as described earlier, the header field analysis information includes a plurality of pieces of packet information of multiple dimensions, e.g., the protocol layering information, the protocol number information, the header length information, the field type information, the field number information, and the nested depth information or the like. In an implementation of the present invention, the packet management program PMP may further first change the packet information of multiple dimensions into information of fewer dimensions (e.g., two dimensions). For example, the packet management program PMP may use a field rule algorithm to calculate a calculation complexity and a calculation storage amount based on the plurality of pieces of packet information included in the header field analysis information. In other words, after the plurality of pieces of packet information of multiple dimensions are converted into information of two dimensions by the packet management program PMP, the information of two dimensions of packet information would be obtained/output (i.e., the “Calculation Complexity” and the “Calculation Storage Amount”). Thereby, the packet management program PMP uses the clustering algorithm to generate the packet efficiency information PEI based on the calculation complexity, the calculation storage amount and the IoT device information 102.

For example, as shown in FIG. 4, the packet management program PMP may first store the header field analysis information into a packet format database DB1, so after reading header field analysis information 400 from the packet format database DB1, the packet management program PMP may selectively use a field rule algorithm to reduce the dimension of the information. Specifically, the packet processing complexity for protocols of different layers may also be different. Generally speaking, the calculation complexity for the analysis and edition of the layer 7 is higher than that of the layer 3, and the calculation complexity for the analysis and edition of the layer 3 is higher than that of the layer 2. Additionally, the “Protocol Number” indicates the number of protocols that need to be processed, the “Field Type” indicates whether the field is of a fixed length or a varied length, the “Field Number” indicates the number of fields that need to be processed, and the “Nested Depth” indicates the depth of the required logic calculation.

Through a field rule generation procedure 401, the packet management program PMP can utilize the field rule algorithm to convert the plurality of pieces of information of multiple dimensions into information of two dimensions, i.e., the calculation complexity 41 and the calculation storage amount 43. The “Calculation Complexity 41” may be used to evaluate the speed of the calculation, and the “Calculation Storage Amount 43” may indicate the data amount that needs to be stored in the storage buffer. Next, as shown in FIG. 5, the packet management program PMP further reads the IoT device information 102 from a device evaluation database DB2, thereby utilizing a packet efficiency modeling procedure 501 to generate the packet efficiency information PEI according to the calculation complexity 41, the calculation storage amount 43 and the IoT device information 102 at the same time.

In detail, the packet management program PMP uses the clustering algorithm of the machine learning to quantify the IoT device information so as to generate the packet efficiency information PEI based on the calculation complexity 41 and the calculation storage amount 43. As shown in the packet efficiency information PEI of FIG. 5, each dot represents a performance distribution of each IoT device when performing the packet processing. It shall be appreciated that, the IoT device information 102 stored in the storage medium 13 may include a plurality of pieces of individual IoT device information, and each of the plurality of pieces of individual IoT device information includes instruction period information, memory capacity information, power consumption information and network load information of an IoT device. Based on the calculation complexity 41 and the calculation storage amount 43, all information included in the IoT device information 102 may be quantified and represented with a particular dimension (e.g., two dimensions, but not limited thereto) by the packet management program PMP.

For example, when the packet efficiency information PEI is represented with two dimensions, the horizontal axis (X axis) thereof may represent the “memory capacity load status”, and the vertical axis (Y axis) may represent the “power consumption status”, but it is not limited thereto. How to utilize the clustering algorithm to obtain the packet efficiency information PEI based on the calculation complexity 41, the calculation storage amount 43 and the IoT device information 102 shall be appreciated by those of ordinary skill in the art depending on the aforesaid description, and thus will not be further described herein.

As described above, in addition to the IoT device information received from the cloud server 21 or from the gateway 23, the IoT device information 102 stored in the storage medium 13 may also include built-in specification information of IoT devices that are currently available on the market. Then, the packet management program PMP utilizes a packet processing prediction procedure 503 and further utilizes the classification algorithm to generate classified packet efficiency information CPEI, and further generates the packet processing prediction message according to the classified packet efficiency information CPEI.

Further speaking, the classified packet efficiency information CPEI of FIG. 5 indicates that the IoT devices are further classified. Here, in the classified packet efficiency information CPEI, the IoT devices represented by the dots of the same gray scale are classified into the same category, and the black dots represent the connected IoT devices (e.g., the hand-held device IoT_d1, the camera IoT_d2 and the refrigerator IoT_d3). For example, in the classified packet efficiency information CPEI, each of the IoT devices may be classified into a high performance group, a medium performance group and a low performance group, respectively. In this way, when the packet edition to be performed by the network administrator makes one of the currently connected IoT devices fall within the low performance group, the packet management program PMP may inform the network administrator of the packet processing prediction performance, generated based on the packet edition set by the network administrator, by using the packet processing ACK information displayed on the graphical user interface GUI_4, as shown in FIG. 3E. Then, after the packet processing prediction message is generated, the network administrator may enable the packet management program PMP to perform a protocol export procedure 505 if he/she is satisfied with the packet processing prediction message. Thereby, the protocol is exported (i.e., at least one control message 104 is generated) according to the packet processing prediction message to achieve the objective of controlling the packet transmission.

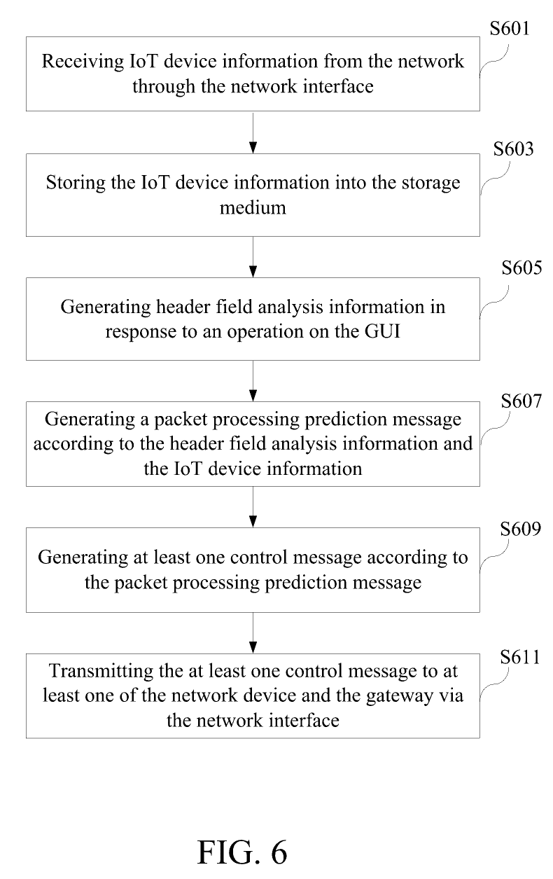

The fourth embodiment of the present invention is a network packet management method, and a flowchart diagram of the method is as shown in FIG. 6. The network packet management method is adapted for use in a network packet management server (e.g., the network packet management server 1 of the aforesaid embodiments). The network packet management server comprises a network interface, a storage medium and a processor. The network interface connects to a network and connects to a network control device and a gateway via the network. The storage medium stores a packet management program. The packet management program includes a graphical user interface (GUI). The processor is electrically connected to the network interface and the storage medium. The network packet management method is executed by the processor through running the packet management program.

First, in step S601, IoT device information is received from the network through the network interface. Next, in step S603, the IoT device information is stored into the storage medium. Thereafter, in step S605, header field analysis information is generated in response to an operation on the GUI. Then, in step S607, a packet processing prediction message is generated according to the header field analysis information and the IoT device information.

In step S609, at least one control message is generated according to the packet processing prediction message. Finally, in step S611, the at least one control message is transmitted to at least one of the network control device and the gateway via the network interface. It shall be noted that, the order in which the steps S601 and S603 and the step S605 are executed is not limited in the present invention. In other words, the steps S601 and S603 and the step S605 may be executed simultaneously, or the steps S601 and S603 may be executed after the step S605. On the other hand, in the network packet management method of this embodiment, the network control device is one of a SDN controller and a switch.

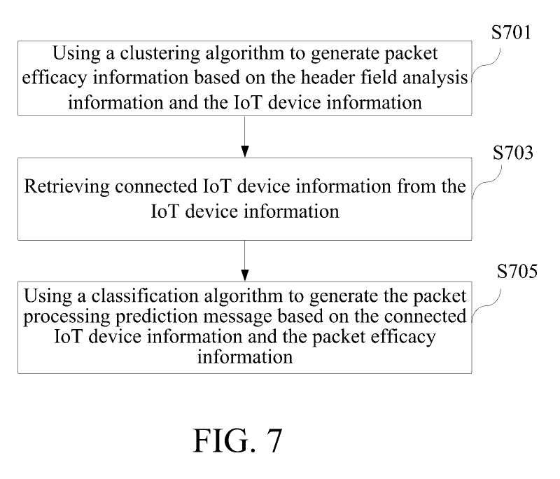

In other embodiments, the step S607 may further comprise steps S701, S703 and S705 as shown in FIG. 7. First, in step S701, a clustering algorithm is used to generate packet efficiency information based on the header field analysis information and the IoT device information. Next, in step S703, connected IoT device information is retrieved from the IoT device information. Finally, in step S705, a classification algorithm is used to generate the packet processing prediction message based on the connected IoT device information and the packet efficiency information. Similarly, the order in which the steps S701 and S703 are executed is not limited in the present invention. In other words, the step S703 may be executed before the step S701, or the steps S701 and the step S703 may be executed simultaneously.

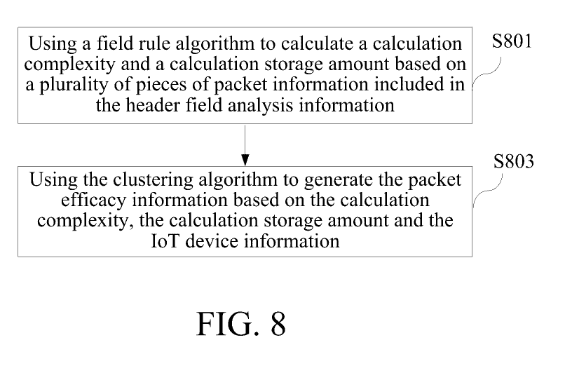

Additionally, in other embodiments, the step S701 may further comprise steps S801 and S803 as shown in FIG. 8. First, in step S801, a field rule algorithm is used to calculate a calculation complexity and a calculation storage amount based on a plurality of pieces of packet information included in the header field analysis information. Next, in step S803, the clustering algorithm is used to generate the packet efficiency information based on the calculation complexity, the calculation storage amount and the IoT device information.

In another embodiment, the network packet management server further comprises an input interface electrically connected to the processor. The input interface is configured to generate an input signal in response to the operation of a user on the GUI. The network packet management method further comprises the following steps of: enabling the GUI to present packet edition information according to the input signal; and generating the header field analysis information according to the packet edition information. Furthermore, in other embodiments, the network packet management method further comprises the following steps of: enabling the GUI to present packet processing ACK information according to the packet processing prediction message so that the input interface further generates another input signal in response to another operation of the user on the GUI; and generating a packet processing ACK message according to the another input signal so as to generate the at least one control message in response to the packet processing ACK message.

In other embodiments, the user may access the network packet management server via other UEs (e.g., a personal computer) to perform an input operation on the GUI via the other UEs, thereby executing the network packet management method via the other UEs and the network packet management server. In this case, the network packet management method further comprises the following steps of: receiving packet edition information from the network through the network interface in response to the operation of a user on the GUI; and generating the header field analysis information according to the packet edition information.

In another embodiment, the network packet management method further comprises the following steps of: generating packet processing ACK information according to the packet processing prediction message; transmitting the packet processing ACK information to a UE via the network interface; receiving a packet processing ACK message from the UE via the network interface; and generating the at least one control message according to the packet processing ACK message. Additionally, in other embodiments, in the case that the network interface further connects to a cloud server via the network, the network packet management method may further comprise the following steps of: receiving the IoT device information from one of the cloud server and the gateway through the network interface and via the network.

On the other hand, in the network packet management method of the present invention, the header field analysis information may be generated according to packet edition information presented by the GUI, and the packet edition information further comprises at least one of packet format information, comparison condition information and translation condition information. Moreover, in other embodiments, the IoT device information stored in the storage medium comprises a plurality of pieces of individual IoT device information, and each of the plurality of pieces of individual IoT device information further comprises instruction period information, memory capacity information, power consumption information and network load information. In addition to the aforesaid steps, the network packet management method of the present invention can also execute all the operations set forth in the aforesaid embodiments and have all the corresponding functions. How this embodiment executes these operations and have these functions will be readily appreciated by those of ordinary skill in the art based on the explanation of the aforesaid embodiments, and thus will not be further described herein.

As can be known from the above descriptions, the network packet management method of the present invention may be executed by a packet management program having a plurality of codes. The packet management program may be stored into a non-transitory tangible computer readable medium. When packet management program are loaded and installed into an electronic device (e.g., the network packet management server), the packet management program executes the network packet management method of the present invention. The non-transitory computer readable medium may be an electronic product, e.g., a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the packet management mechanism of the present invention provides the network administrator with a packet management tool, through which the processing performance when the IoT device processes the packet can be predicted (i.e., a packet processing prediction message can be generated) according to the packet edition information inputted by the network administrator and the capacity of the IoT device (i.e., the IoT device information). If the network administrator is satisfied with the packet processing prediction result (or when the packet processing prediction result is determined to be acceptable), then a control message may accordingly be generated, thereby achieving the objectives of monitoring, managing and editing the packet transmission and so on. Accordingly, the packet management mechanism of the present invention can effectively assist the network administrator in evaluating in advance whether a packet management demand thereof is suitable for the current IoT environment, and automatically generate a control message in response to the acknowledgement of the network administrator so as to control a gateway or other network controlling devices connected to the IoT device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network packet management server, comprising:
a network interface connecting to a network, being configured to receive internet of things (IoT) device information via the network and connect to a network control device and a gateway via the network;
a storage medium, being configured to store the IoT device information and a packet management program that includes a graphical user interface (GUI); and
a processor electrically connected to the network interface and the storage medium, being configured to run the packet management program so as to generate header field analysis information in response to an operation on the GUI, generate a packet processing prediction message according to the header field analysis information and the IoT device information, generate at least one control message according to the packet processing prediction message, and transmit the at least one control message to at least one of the network control device and the gateway via the network interface.

2. The network packet management server of claim 1, further comprising an input interface electrically connected to the processor, wherein the input interface is configured to generate an input signal in response to the operation of a user on the GUI, and the packet management program further enables the GUI to present packet edition information according to the input signal and generates the header field analysis information according to the packet edition information.

3. The network packet management server of claim 2, wherein the packet management program further enables the GUI to present packet processing acknowledgement (ACK) information according to the packet processing prediction message so that the input interface further generates another input signal in response to another operation of the user on the GUI, and the packet management program generates a packet processing ACK message according to the another input signal so as to generate the at least one control message in response to the packet processing ACK message.

4. The network packet management server of claim 1, wherein the network interface further receives packet edition information via the network in response to the operation of a user on the GUI, and the packet management program further generates the header field analysis information according to the packet edition information.

5. The network packet management server of claim 4, wherein the packet management program further generates packet processing ACK information according to the packet processing prediction message and transmits the packet processing ACK information to a user equipment (UE) via the network interface, and the network interface further receives a packet processing ACK message from the UE via the network so that the packet management program generates the at least one control message according to the packet processing ACK message.

6. The network packet management server of claim 1, wherein the header field analysis information is generated according to packet edition information presented by the GUI, and the packet edition information further comprises at least one of packet format information, comparison condition information and translation condition information.

7. The network packet management server of claim 1, wherein the packet management program further uses a clustering algorithm to generate packet efficiency information based on the header field analysis information and the IoT device information, and the packet management program further retrieves connected IoT device information from the IoT device information and uses a classification algorithm to generate the packet processing prediction message based on the connected IoT device information and the packet efficiency information.

8. The network packet management server of claim 7, wherein the packet management program further uses a field rule algorithm to calculate a calculation complexity and a calculation storage amount based on a plurality of pieces of packet information included in the header field analysis information, and further uses the clustering algorithm to generate the packet efficiency information based on the calculation complexity, the calculation storage amount and the IoT device information.

9. The network packet management server of claim 8, wherein the IoT device information stored in the storage medium comprises a plurality of pieces of individual IoT device information, and each of the plurality of pieces of individual IoT device information comprises instruction period information, memory capacity information, power consumption information and network load information of an IoT device.

10. The network packet management server of claim 1, wherein the network interface further connects to a cloud server via the network, and the network interface receives the IoT device information from one of the cloud server and the gateway via the network.

11. The network packet management server of claim 1, wherein the network control device is one of a software defined network (SDN) controller and a switch.

12. A network packet management method for use in a network packet management server, the network packet management server comprising a network interface, a storage medium and a processor, the network interface connecting to a network and connecting to a network control device and a gateway via the network, the storage medium being configured to store a packet management program that includes a GUI, the processor being electrically connected to the network interface and the storage medium, and the network packet management method being executed by the processor through running the packet management program, the method comprising:
receiving IoT device information through the network interface and via the network, and storing the IoT device information into the storage medium;
generating header field analysis information in response to an operation on the GUI;
generating a packet processing prediction message according to the header field analysis information and the IoT device information;
generating at least one control message according to the packet processing prediction message; and
transmitting the at least one control message to at least one of the network control device and the gateway via the network interface.

13. The network packet management method of claim 12, wherein the network packet management server further comprises an input interface electrically connected to the processor, the input interface is configured to generate an input signal in response to the operation of a user on the GUI, the network packet management method further comprising:
the GUI presenting packet edition information according to the input signal; and
generating the header field analysis information according to the packet edition information.

14. The network packet management method of claim 13, further comprising:
the GUI presenting packet processing ACK information according to the packet processing prediction message so that the input interface further generates another input signal in response to another operation of the user on the GUI; and
generating a packet processing ACK message according to the another input signal so as to generate the at least one control message in response to the packet processing ACK message.

15. The network packet management method of claim 12, further comprising:
receiving packet edition information from the network through the network interface in response to the operation of a user on the GUI; and
generating the header field analysis information according to the packet edition information.

16. The network packet management method of claim 15, further comprising:
generating packet processing ACK information according to the packet processing prediction message;
transmitting the packet processing ACK information to a UE via the network interface;
receiving a packet processing ACK message from the UE via the network interface; and
generating the at least one control message according to the packet processing ACK message.

17. The network packet management method of claim 12, wherein the header field analysis information is generated according to packet edition information presented by the GUI, and the packet edition information further comprises at least one of packet format information, comparison condition information and translation condition information.

18. The network packet management method of claim 12, further comprising:
using a clustering algorithm to generate packet efficiency information based on the header field analysis information and the IoT device information;
retrieving connected IoT device information from the IoT device information; and
using a classification algorithm to generate the packet processing prediction message based on the connected IoT device information and the packet efficiency information.

19. The network packet management method of claim 18, further comprising:
using a field rule algorithm to calculate a calculation complexity and a calculation storage amount based on a plurality of pieces of packet information included in the header field analysis information; and
using the clustering algorithm to generate the packet efficiency information based on the calculation complexity, the calculation storage amount and the IoT device information.

20. The network packet management method of claim 19, wherein the IoT device information stored in the storage medium comprises a plurality of pieces of individual IoT device information, and each of the plurality of pieces of individual IoT device information further comprises instruction period information, memory capacity information, power consumption information and network load information.

21. The network packet management method of claim 12, wherein the network interface further connects to a cloud server via the network, the network packet management method further comprising:
receiving the IoT device information from one of the cloud server and the gateway through the network interface and via the network.

22. The network packet management method of claim 12, wherein the network control device is one of a software defined network (SDN) controller and a switch.

23. A non-transitory tangible computer readable medium with a packet management program stored therein, the packet management program including a GUI and a plurality of codes, wherein when the packet management program is loaded and installed into a network packet management server, the codes are executed by the network packet management server to execute a network packet management method, and the network packet management server connects to a network, the network packet management method comprising:
receiving IoT device information via the network, and storing the IoT device information;
generating header field analysis information in response to an operation on the GUI;
generating a packet processing prediction message according to the header field analysis information and the IoT device information;
generating at least one control message according to the packet processing prediction message; and
transmitting the at least one control message to at least one of the network control device and the gateway.
